(19) United States
(12) Patent Application Publication
(10) Pub. No.: US 2020/0127279 A1
(43) Pub. Date: Apr. 23, 2020

(54) Electrochemically Exfoliated Phosphated Graphene

(71) Applicant: UTI Limited Partnership, Calgary (CA)

(72) Inventors: Edward P.L. Roberts, Calgary (CA); Farbod Sharif, Calgary (CA); Milana Trifkovic, Calgary (CA); Steven Bryant, Calgary (CA)

(73) Assignee: UTI Limited Parternship, Calgary, AB (CA)

(21) Appl. No.: 16/656,586

(22) Filed: Oct. 18, 2019

Related U.S. Application Data
(60) Provisional application No. 62/747,566, filed on Oct. 18, 2018.

(51) Int. Cl. H01M 4/133; H01M 4/1393; H01M 4/62; C01B 32/194; C01B 32/19

(52) U.S. Cl. CPC H01M 4/133; H01M 4/1393; C01B 32/19; C01B 32/194; H01M 4/625

(57) ABSTRACT

An electrochemically exfoliated phosphated (EEP) graphene is provided, including EEP graphenes having phosphorous-containing functional groups at a surface of the EEP graphene in an amount sufficient to improve thermal stability of the EEP graphene. Process for electrochemically producing the EEP graphene are also provided.

### FIELD

The invention is in the field of graphene chemistry.

### BACKGROUND

Graphene, with its unique 2-dimensional honeycomb structure, has attracted a significant amount of attention in electrochemistry due to its exceptional properties, such as its large aspect ratio, high surface area, superior conductivity, and catalytic activity [1]. Graphene-based materials with tunable surface chemistry have for example been suggested for use as catalysts [2], catalyst supports [3,4], and adsorption media [5,6], in applications such as fuel cells [7], sensors [8], and batteries [9]. Graphene has been synthesized by a variety of different methods, such as mechanical exfoliation of graphite [10], chemical vapor deposition (CVD) [11] reduction of graphene oxide [12] and electrochemical exfoliation of graphite [13].

Electrochemically exfoliated graphene has primarily been synthesized in three alternative electrolytes: ionic liquids [14,15], acidic aqueous media [16,17], and aqueous media containing inorganic salts [18,19]. The use of inorganic salts has been reported to produce graphene with large lateral size and lower amounts of oxygen functional groups compared to other types of electrolytes [20]. Alternative approaches have been reported for synthesizing exfoliated graphene using two-step electrochemical intercalation and oxidation processes [21, 22].

The catalytic properties of graphene can be tuned by modifying the atomic structure of graphene through doping with heteroatoms. Among the dopants that have been studied, nitrogen has drawn significant interest [23]. N-doped graphene has been evaluated as an electrode material for oxygen reduction reaction [24], lithium batteries [25], sensors [26] and supercapacitors [27]. N-doped graphene, along with other graphitic materials, have been suggested for use in activation of oxygen in the context of organic degradation reactions [28, 29, 30]. There have been a number of efforts to increase the catalytic activity of doped graphene through co-doping of nitrogen with other heteroatoms such as sulfur [31], boron [32] or phosphorous [33].

The lifespan of graphene-based materials can be shortened when they are utilized in applications requiring high-temperature conditions in an oxidative environment [4]. A variety of approaches have been suggested for enhancing the durability of graphitic materials at high temperature. In one approach, a graphene surface may be covered with other materials, which act as a diffusion barrier (physical blockage) to oxidants [34, 35]. Alternatively, an active site can be blocked using chemicals such as boron or phosphorous which act as a resistive surface complex (active site poisoning) [34,36-42].

### SUMMARY

One general aspect of the present innovations includes an electrochemically exfoliated phosphated (EEP) graphene, including phosphorous-containing functional groups at a surface of the EEP graphene in an amount sufficient to improve thermal stability of the EEP graphene compared to a graphene lacking the phosphorous-containing functional groups. Implementations may include one or more of the following features. The EEP graphene where a thermal gravimetric temperature measurement at 50% mass loss in air is at least 550, 600, 650, 700, 750, 800, 850 or 873° C. The EEP graphene where a Raman spectrum of the EEP graphene has an ID/IG ratio of about 0.25. Use of the electrochemically exfoliated phosphated graphene as a conductor, catalyst, or electrocatalyt, including use for electro-oxidation, oxygen reduction, water electrolysis, or as a battery electrode. An electrode including the EEP graphene. The electrode where the electrode is an anode.

One general aspect includes a process for synthesizing electrochemically exfoliated phosphated graphene, including applying an electrochemical exfoliation current to an exfoliation anode including a graphite sample in an phosphating electrolyte that is an inorganic salt solution including diammonium phosphate (NH₄)₂HPO₄ and/or mono-ammonium phosphate (NH₄)H₂PO₄. Implementations may include one or more of the following features. The process where the electrochemical exfoliation current is a DC current. The process where the DC current density applied to the electrode is about 20 mA per cm² of the graphite anode, or from 5 to 500 mA/cm². The process where the phosphating electrolyte comprises one or more of (NH₄)₂SO₄, NH₄NO₃, H₂SO₄, or Na₂SO₄, or includes a mixture of ammonium sulfate (NH₄)₂SO₄ and diammonium phosphate (NH₄)₂HPO₄. The process where the total salt concentration is about 0.1 M, or from 0.05 M to saturated solution, or the sum of the concentrations of (NH₄)₂SO₄ and (NH₄)₂HPO₄ is maintained at about 0.1 M, or from 0.05 M to saturated solution. The process where the ratio between (NH₄)₂SO₄ and (NH₄)₂HPO₄ is from 9:1 to 1:1; or, is about 7:3.

One general aspect includes a process for synthesizing electrochemically exfoliated phosphated graphene, including intercalation of a graphite sample to provide an intercalated graphite; and, exfoliation of the intercalated graphite to provide the electrochemically exfoliated phosphated graphene, where: intercalation of the graphite sample includes applying an electrochemical intercalation current to an intercalation anode including the graphite sample in an acidic aqueous intercalation electrolyte including phosphoric acid in electrical contact with an intercalation cathode; and. The process also includes exfoliation of the intercalated graphite includes applying an electrochemical exfoliation current to an exfoliation anode including the intercalated graphite in an inorganic salt solution electrolyte in electrical contact with an exfoliation cathode.

Implementations may include one or more of the following features. The process where the inorganic salt solution includes diammonium phosphate (NH₄)₂HPO₄ and/or mono-ammonium phosphate (NH₄)H₂PO₄. The process where the (NH₄)₂HPO₄ and/or (NH₄)H₂PO₄ solution is 0.1 moles per liter, or from 0.05 M to saturated solution. The process where the inorganic salt solution includes ammonium sulfate (NH₄)₂SO₄, NH₄NO₃, H₂SO₄, or Na₂SO₄. The process where the total inorganic salt concentration or the (NH₄)₂SO₄ concentration is 0.1 moles per liter, or from 0.05 M to saturated solution. The process where the intercalation cathode and/or the exfoliation cathode is stainless steel, graphite, or platinum. The process where applying the electrochemical intercalation current and/or the electrochemical exfoliation current includes fixing the distance between the electrodes and apply a constant DC voltage the anode and cathode. The process where applying the electrochemical intercalation current and/or the electrochemical exfoliation current includes applying a fixed dc current density to the electrodes. The process where the fixed DC current density of the electrochemical exfoliation current is about 20 mA per cm² of the intercalated graphite on the anode, or from 5 to 500 mA/cm². The process further including applying the electrochemical exfoliation current to the cell until the intercalated graphite has fully exfoliated. The process where the intercalation electrolyte includes a mixture of sulfuric and phosphoric acids. The process where the sulfuric acid is concentrated (optionally 95-98%) sulfuric acid. The process where the phosphoric acid is concentrated phosphoric acid (optionally 85%). The process where the volume ratio of sulphuric to phosphoric acid is from 95:5 to 80:20. The process where the volume ratio of sulphuric acid to phosphoric acid is from 50:50 to 95:5. The process where the graphite sample is a flexible graphite sheet.

In summary, facile electrochemical exfoliation approaches are provided to produce distinct electrochemically exfoliated graphene with excellent high-temperature stability. Methods are based on graphene exfoliation in inorganic electrolytes (e.g. (NH₄)₂HPO₄ and (NH₄)₂SO₄) where the electrolyte composition is shown to have a significant impact on the yield, morphology, structure, and high-temperature stability of the graphene sheets. Graphene prepared using (NH₄)₂HPO₄ electrolyte showed a low level of defects in comparison to other electrochemically exfoliated graphene and an exceptional high-temperature stability in air, for example at temperatures of up to 750° C. In select embodiments, the addition of (NH₄)₂SO₄ to the (NH₄)₂HPO₄ electrolyte improved the exfoliation process and increased the production of single layer graphene sheets from 19% to ˜50%. These hybrid electrolytes also led to nitrogen, phosphorus, and sulphur tri-doped graphene sheets with fewer defects and high-temperature stability in air. This simple process may be adapted for large scale preparation of doped graphene with fewer defects and exceptional properties for various applications.

### BRIEF DESCRIPTION OF THE DRAWINGS

FIG. 1 (i) Raman mapping of synthesized graphene and (ii) the corresponding ID/IG of the mapped graphene. (a) Na₂SO₄, (b) (NH₄)₂SO₄, (c) NH₄NO₃, and (d) (NH₄)₂HPO₄.

FIG. 2 (i) TEM image of synthesized graphene, (ii) SAED pattern from corresponding graphene; (a) Na₂SO₄, (b) (NH₄)₂SO₄, (c) NH₄NO₃, and (d) (NH₄)₂HPO₄.

FIG. 3 includes (a) XPS spectra of the synthesized graphenes, and (b) high-resolution C1s, N1s, S2p, and P2P spectra of the synthesized graphenes.

FIG. 4 includes 4 graphs illustrating (a) TGA and (b) DTG graphs of different synthesized graphenes. (c) TGA and (d) DTG graphs of synthesized GOs using hybrid electrolytes.

FIG. 5 is a cyclic voltagram of ferricyanide and ferrocyanide redox reactions, carried out to illustrate the catalytic activity of alternative graphene electrodes.

FIG. 6 is a cyclic voltagram of phenol oxidation, carried out to illustrate the catalytic activity of alternative graphene electrodes.

FIG. 7 includes two graphs: (a) shows the effect of the scan rate on the anodic current peak of the phenol oxidation on the graphene prepared using 1M (NH₄)₂HPO₄; and, (b) is a linear plot of oxidation peak vs. scan rate.

FIG. 8 includes Nyquist plots for electrochemically synthesized graphene using (a) different salts (b) different voltages (c) different concentrations in 2.5 mM [Fe(CN)₆]^{4-/3-}+0.1 M KCl.

FIG. 9 is a schematic illustration of a two stage electrochemical exfoliation procedure for graphene synthesis.

FIG. 10 is a schematic illustration of a single stage electrochemical exfoliation procedure for graphene synthesis.

FIG. 11 illustrates the results of thermal gravimetric analysis of EEP graphene obtained by a two-step intercalation and exfoliation process.

FIG. 12 illustrates the Raman spectra of EEP graphene obtained by a two-step intercalation and exfoliation process.

FIG. 13 illustrates the FTIR spectra of EEP graphene obtained by a two-step intercalation and exfoliation process.

FIG. 14 is a bar graph illustrating the comparative electrical conductivity of EEP graphene, showing data from electrochemically exfoliated graphenes prepared using the different electrolytes set out in the graph.

### DETAILED DESCRIPTION

As exemplified herein, electrochemically exfoliated phosphated (EEP) graphene exfoliated in ammonium phosphate was found to have an unusually high thermal stability in air, with very little mass loss up to 750° C. This illustrates that phosphorus functional groups, putatively at the surface and the periphery of the graphene, provide thermal stability to the phosphated graphene. This thermal stability is highly unusual for high surface area carbon materials, which are typically unstable at temperatures of 400 to 500° C. This resistance to oxidation is evidence that, in select embodiments, this EEP graphene material may for example be used in anodic applications, for example so as to reduce anodic corrosion. Similarly, the EEP graphene may be used as an electrode or in alternative conformations as a conductor for current supply (for example in high temperature electrochemical technologies).

In an exemplary embodiment, EEP graphene exfoliated in ammonium phosphate and ammonium sulfate electrolytes showed a high degree of catalytic activity for phenol oxidation. Select embodiments accordingly provide for use of EEP graphenes in electro-oxidation, including nitrogen and phosphorous co-doped EEP graphenes. The phenol electro-oxidation process was found to be an adsorption controlled process, and the EEP graphene materials may accordingly be provided in embodiments having high active surface areas for oxidation.

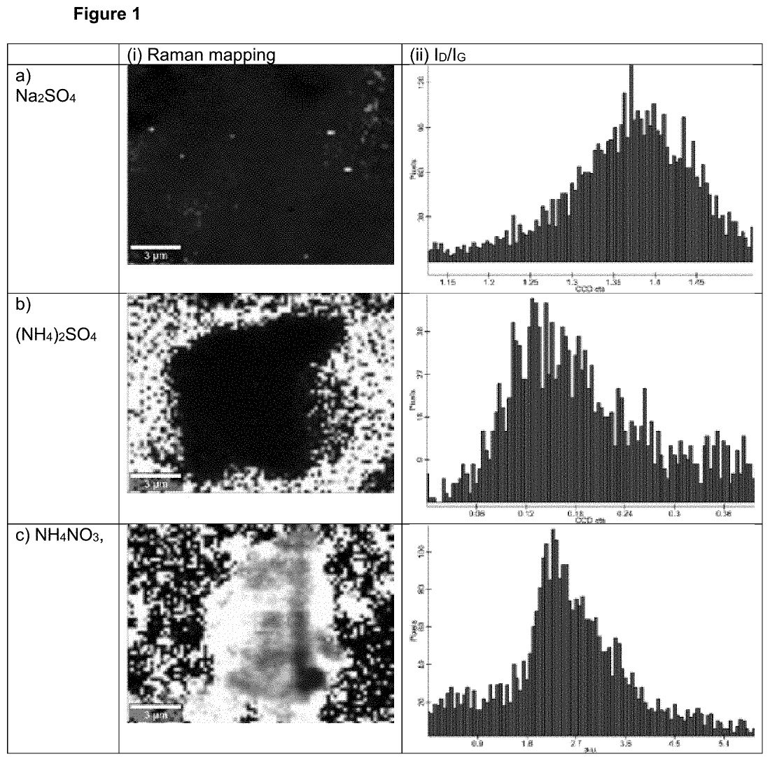

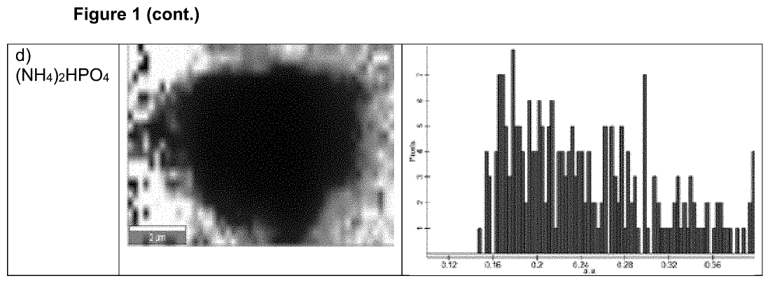

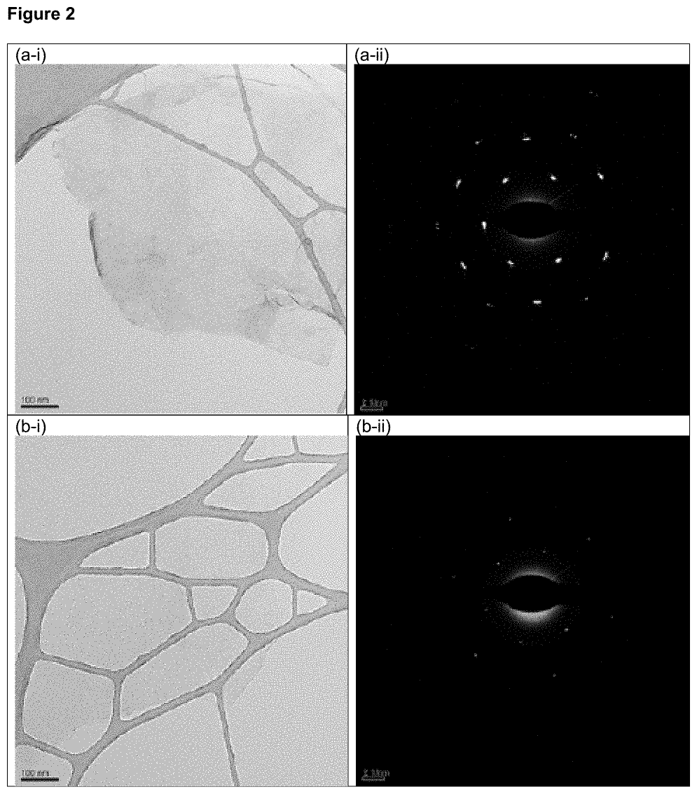

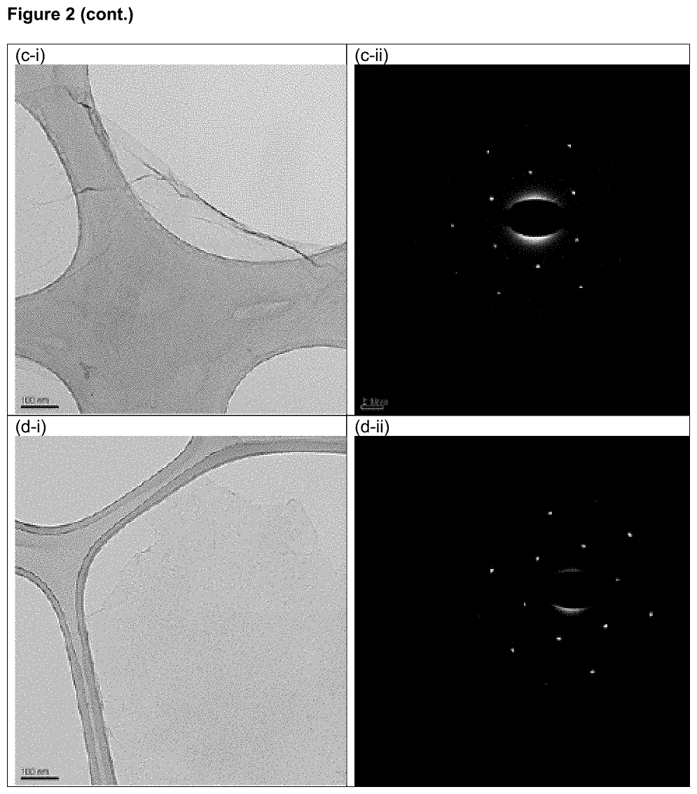

Raman spectroscopy was employed to measure the defects in the prepared EEP graphenes coated on a silicon wafer. The Raman Spectra of graphene is characterized by a D band (ca. 1350 cm⁻¹) arising from a breathing mode of the sp2 carbon atoms due primarily to defects in the graphene structure, typically attributable to functional groups or structural disorder. A G band (ca. 1580 cm⁻¹) in the Raman Spectra of graphene is caused by in-plane vibration of sp2 carbon atoms. The intensity ratio of ID/IG can accordingly be used as a criteria by which to characterize the degree of disorder in a graphene (Stankovich et al. 2007). As exemplified herein, due to incomplete exfoliation, a graphene sample prepared in NaCl maintained a graphitic structure and was characterized by a low ratio of ID/IG of 0.01. FIG. 1 depicts Raman mapping of the ID/IG for electrochemically exfoliated graphenes using alternative salts. The contrast in shade (darker) between FIG. 1b and FIG. 1c demonstrates a contrast where the intensity of the G band is more than D band, representative of a reduced occurrence of defects. The sample prepared using (NH₄)₂HPO₄ showed an ID/IG ratio of 0.25. In the exemplified embodiments, the ID/IG ratio changes significantly depending on the salt used for exfoliation, with the degree of disorder increasing in order: (NH₄)₂HPO₄>(NH₄)₂SO₄>Na₂SO₄>NH₄NO₃ evidencing an increase in the degree of structural defects and attendant functionalization for these samples.

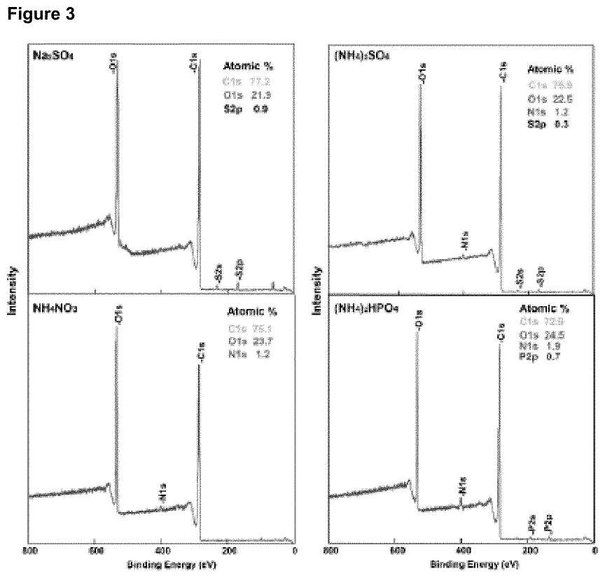

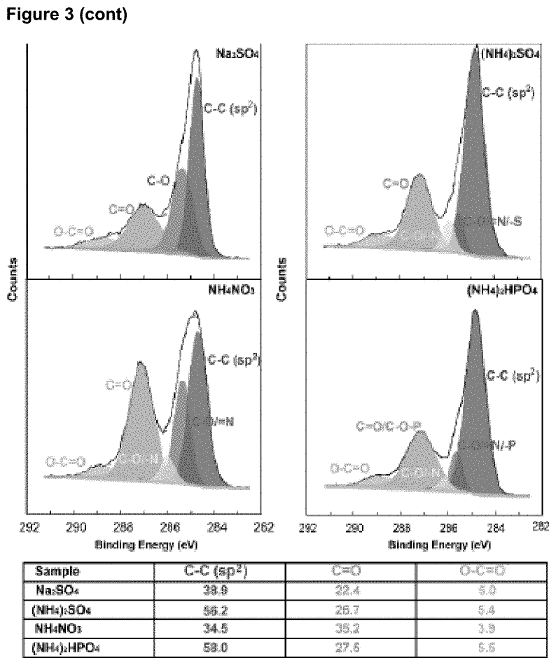

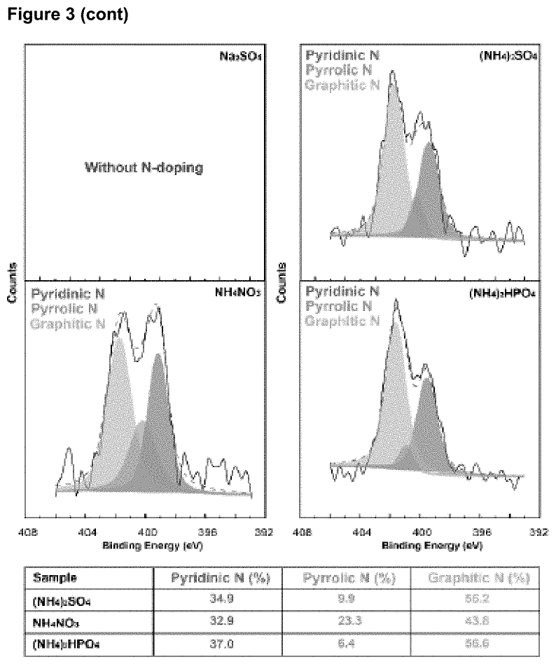

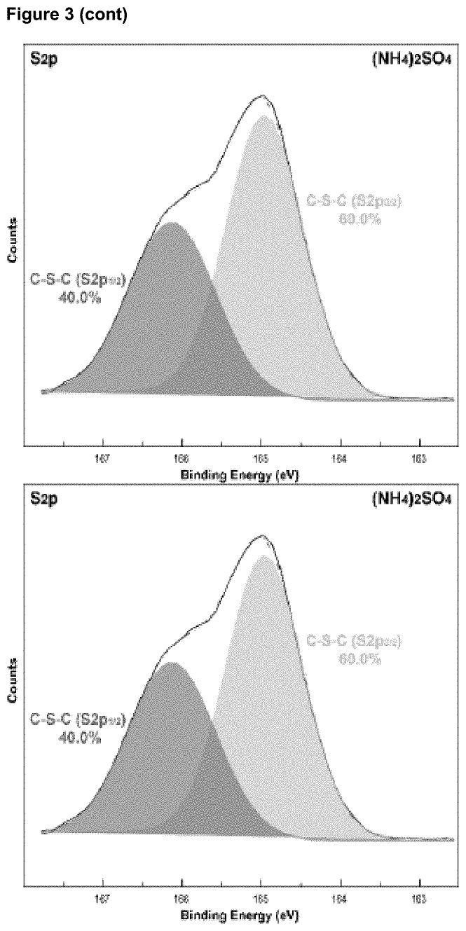

The chemical nature of the synthesized graphenes was illustrated by X-ray photoelectron spectroscopy (XPS). The survey (FIG. 3) confirms the existence of C and O for all graphenes and N for graphenes synthesized with (NH₄)₂SO₄, NH₄NO₃, and (NH₄)₂HPO₄. Moreover, the survey indicates the presence of sulphur (S) and phosphorous (P) in graphene-NH₄NO₃ and graphene-(NH₄)₂HPO₄, respectively. As can be seen, the highest amount of the oxygen is for graphene synthesized in NH₄NO₃ solution, implying a higher degree of oxidation. The oxygen groups at the surface of graphenes originate from the oxidation of graphite by ions during the electrochemical exfoliation. In addition, the calculated atomic ratio for different graphenes demonstrates the doping potential of (NH₄)₂HPO₄ as an electrolyte.

To illustrate the chemical surface nature of the graphenes, high resolution of Cs1, Ns1, S2p and P2p are indicated in FIG. 3. XPS C1s spectra peaks can be deconvoluted to four peaks at 284.5 eV, 258.3 eV, 287.8 eV, and 289.2 eV, corresponding graphitic carbons (sp2carbon), C—O, C═O, and O—C═O, respectively [4-9]. There was one additional peak in the case of N-doped electrochemically exfoliated graphene at 286.2 eV, corresponding to the C—O or C—N bonds. The XPS Cs1 spectrum of graphene-NH₄NO₃ was characterized by a highly intense peak at 287.8 eV, corresponding to the formation of C═O and —COO— groups which can break C—C bonds, leaving permanent vacancy/hole defects in the graphene structure. This confirms the high degree of oxidation during the exfoliation for graphite in the NH₄NO₃ electrolyte. These results are also indicative of less damage to the graphitic structure in the graphene synthesized with (NH₄)₂HPO₄ and (NH₄)₂SO₄ compared to the NH₄NO₃ and Na₂SO₄ (considering the C—C peaks).

After deconvolution of Ns1, it is clearly evident that the spectra contain three peaks at 399.2, 400.3, and 401.7 eV corresponding to the pyridinic N, pyrrolic N, and graphitic N, respectively [5, 10, 11]. The graphitic N-doping can improve the electrical conductivity of the electrochemically exfoliated graphene while the pyrrolic N can create abundant extrinsic defects and active sites on the graphene basal plane. The high intensity of peak assigned to pyrrolic N for graphene-NH₄NO₃ suggests a higher defect amount for this graphene. Additionally, the high resolution of S2p spectrum for graphene-(NH₄)₂SO₄ can be decomposed into two different peaks at 164.9 eV and 166.1 eV that can be assigned to 2p3/2 and 2p1/2, respectively [12-14]. S2p3/2 and S2p1/2 peaks account for the most of the S content, confirming the integration of S atoms into the graphene lattice of graphene-(NH₄)₂SO₄. Based on the deconvolution of the high resolution of P2p, three peaks can be fitted at 132.9 eV, 133.7 eV, for P—C, C—P—O, and C—O—P bonding configuration, respectively [15-20]. The main component of the P2p XPS is P—C bonding, indicating that P is successfully incorporated into the graphene lattice. The peaks at higher binding energy are attributed to P-containing functional groups as shown in FIG. 3. A co-doped graphene structure combined with phosphorous functional is accordingly provided, which may be used for a wide variety of applications due to its catalytic efficiency, thermal stability, and electro-oxidation resistance.

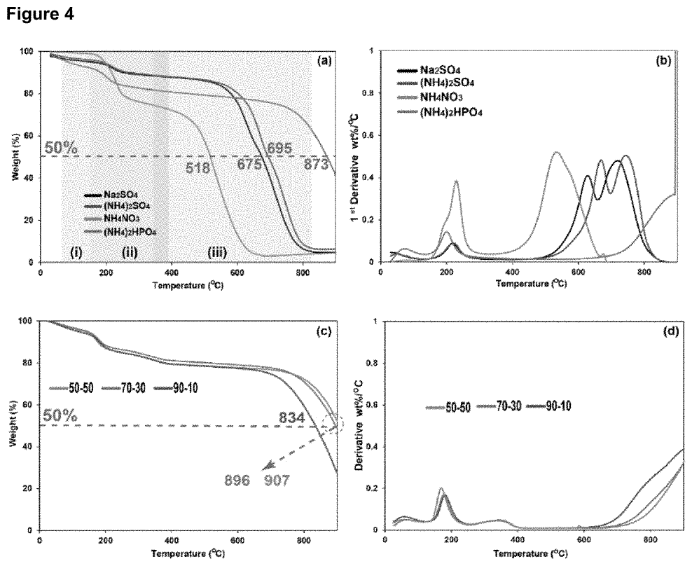

Thermal gravimetric analysis (TGA) was performed in air to illustrate the thermal stability and behavior of synthesized graphenes (FIG. 4). The TGA spectra for all graphenes displayed three major steps: namely (i) the first stage happens around 100° C. due to the evaporation of absorbed water; (ii) the second stage (starts about 150° C.) can be attributed to the transformation of oxygen-containing functional groups to CO and CO₂, where graphene-NH₄NO₃ shows the maximum wt % loss. This correlates to the higher number of oxygen functional groups identified by XPS for this graphene; (iii) the third stage weight loss was caused by the removal of residual functional groups and degradation of the graphene material. A major difference is observed where graphene-(NH₄)₂HPO₄ thermogram clearly shows that this graphene is thermally stable comparing to the other synthesized graphenes. For the temperature at 50% mass loss, this value for graphene-NH₄NO₃ and graphene-(NH₄)₂HPO₄ are 518° C. and 873° C., respectively. This phenomenon can be ascribed to the lower total content of oxygen functional groups and more graphitic (sp2) content for graphene-(NH₄)₂HPO₄, as indicated by XPS results. In addition, P-doping in addition to the phosphorous containing functional groups at the surface of graphene can enhance thermal stability. To illustrate the effect of (NH₄)₂HPO₄ as an electrolyte on the thermal stability of the synthesized graphene, hybrid electrolytes using a different ratio of (NH₄)₂HPO₄ and (NH₄)₂SO₄ were prepared. The thermal stability of the prepared graphenes is illustrated in FIG. 4c and FIG. 4d. For reference, the electrolyte named 90-10 contains 10% (NH₄)₂HPO₄ and 90% (NH₄)₂SO₄. As illustrated, embodiments having at least 30% (NH₄)₂HPO₄ in the (NH₄)₂SO₄ electrolyte exhibited almost the same thermal stability.

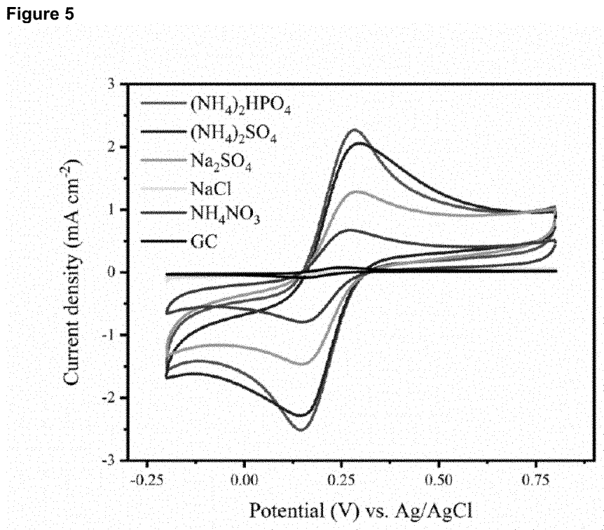

A cyclic voltammogram of the ferricyanide and ferrocyanide was carried out to illustrate the catalytic activity of electrodes prepared using the prepared graphenes (FIG. 5). Cyclic voltammetries were performed using 2.5 mM [Fe(CN)₆]^{4-/3-} and 0.1 M KCl. The redox peak currents of ferricyanide and ferrocyanide was enhanced by coating the surface of glassy carbon by the graphenes prepared using (NH₄)₂HPO₄, (NH₄)₂SO₄, Na₂SO₄ and NH₄NO₃, in contrast to the graphene prepared using NaCl.

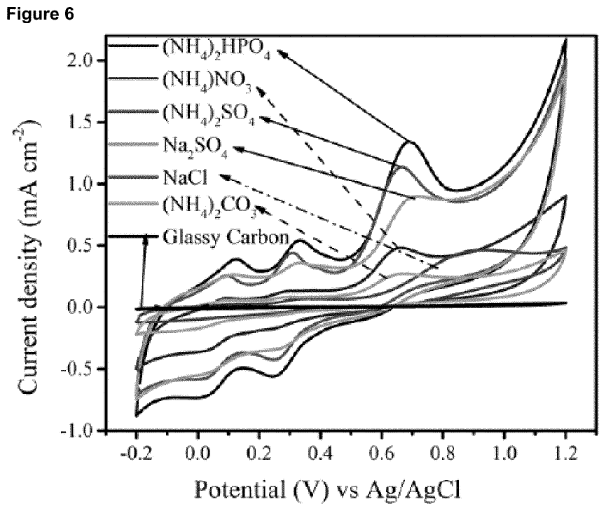

Electrochemical oxidation of phenol was also carried out, by cyclic voltammetry in a solution containing 100 ppm phenol and 50 mM PBS (pH 7.0). The examples involved using a bare glassy carbon electrode and modified glassy carbon electrode with electrochemically synthesized graphene cast on the surface. FIG. 6 shows cyclic voltammetry of phenol oxidation for the first two cycles using graphene prepared in (NH₄)₂HPO₄ at a concentration of 0.1 M, with a cell voltage of 10 V. FIG. 6 shows the effect of the salt used on the electrocatalytic activity of the synthesized graphene for phenol oxidation. The oxidation peak current of the modified electrodes is significantly improved, to the extent that the oxidation peak of phenol on glassy carbon is negligibly small relative to the peak obtained with the graphene modified electrodes. Compared to the samples prepared with ammonium based salts (i.e. (NH₄)₂HPO₄, (NH₄)₂SO₄, NH₄NO₃), samples prepared in NaCl and Na₂SO₄ showed a poorly defined phenol oxidation peak and pairs of poorly defined redox peaks for catechol-orthoquinone and hydroquinone-paraphenol.

The lower activity of graphene prepared using NaCl can be attributed to the incomplete exfoliation shown in the TEM and Raman results. Samples prepared using (NH₄)₂HPO₄, (NH₄)₂SO₄ salts showed higher current oxidation peak. The sample prepared using (NH₄)₂SO₄ showed a phenol oxidation peak at 0.66 V versus Ag/AgCl, however for the sample prepared using (NH₄)₂HPO₄, the phenol oxidation peak was observed at 30 mV higher potential. On the other hand, the peak separation for catechol-orthoquinone and hydroquinone-paraphenol redox reactions are 60 mV and 70 mV respectively on the graphene prepared using (NH₄)₂SO₄, while these peak separations are 80 and 100 mV for graphene prepared in (NH₄)₂HPO₄.

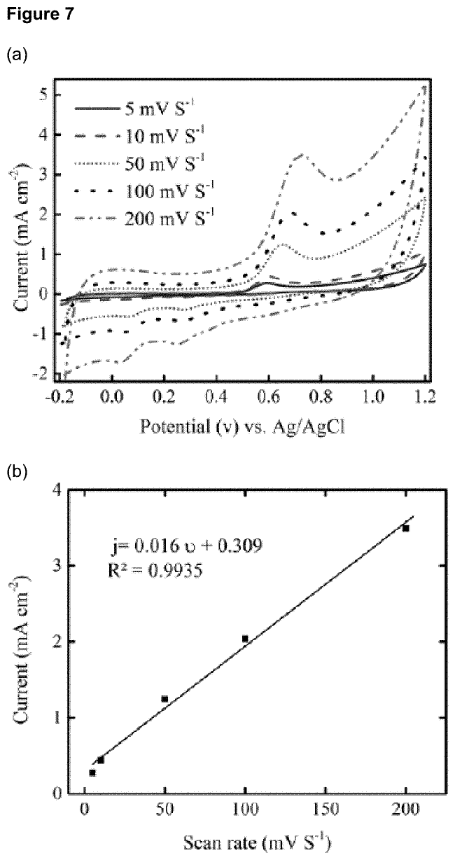

FIG. 7(a) shows the effect of the scan rate on the anodic current peak of the phenol oxidation on the graphene prepared using 1M (NH₄)₂HPO₄ and FIG. 7(b) is a linear plot of oxidation peak vs. scan rate. FIG. 7b illustrates that the oxidation currents grow linearly with increasing scan rate. This behavior indicates that that the oxidation of phenol on the electrochemically exfoliated graphene is an adsorption-controlled process.

FIG. 8 shows the electrochemical impedance spectroscopy (EIS) data, presented as Nyquist plots, for graphene materials obtained under a range of different conditions. The Faradaic charge transfer resistance (Rct) can be obtained from the diameter of the semicircular in the high frequency part of the Nyquist plots [49,50]. FIG. 8a shows the Nyquist plot for graphene materials prepared using a range of different salts. For the sake of simplicity, all of the graphs were normalized with respect to the solution resistance. Rct was calculated using a simple circle fitting. The impedance spectra are consistent with the findings from the cyclic voltammetry. The graphene prepared using NH₄NO₃ was found to have a much higher charge transfer resistance (ca. 98Ω) compared to the other samples. The other samples all showed only slight differences in the charge transfer resistance, in the order (NH₄)₂SO₄<(NH₄)₂HPO₄<Na₂SO₄<NaCl.

As disclosed herein, graphene sheets with reduced defects and high-temperature stability were synthesized using a facile electrochemical exfoliation approach, with the impact of the synthesis conditions on the physical/chemical structure of EEP graphenes illustrated. In select embodiments, EEP graphene prepared with phosphate and sulfate anions had a reduced amount of functional groups compared to graphenes prepared using other salts. Graphene exfoliated in ammonium phosphate electrolyte was found to have an unusually high-temperature stability in air, with very little mass loss up to 750° C., associated with phosphorus functional groups at the surface and the periphery of the graphene. This is highly unusual for a high surface area carbon material, as they are typically unstable at temperatures of 400 to 500° C. Methods using a mixed electrolyte containing different ratios of (NH₄)₂HPO₄ and (NH₄)₂SO₄ are exemplified, and the EEP graphenes exfoliated in (NH₄)₂HPO₄ or mixed electrolytes exhibited a high degree of crystallinity and few defects, putatively due to the phosphorous functional groups binding with diols during the exfoliation process and thereby ameliorating further oxidation of the surface. The EEP graphene prepared using (NH₄)₂HPO₄ containing electrolytes had fewer defects than the other electrochemically exfoliated graphenes. The EEP graphenes prepared using mixed electrolytes demonstrated high temperature stability, similar to EEP graphene prepared in pure (NH₄)₂HPO₄, while possessing a higher number of the monolayer (≅50%) and bilayer (≅40%) sheets.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

### EXAMPLES

The Examples herein relate to the electrochemical exfoliation of graphite into graphene using a range of inorganic salts. The effects of changing conditions such as salt type, salt concentration and cell voltage on the graphene structure and catalytic activity were exemplified using transmission electron microscopy, Raman spectroscopy, thermogravimetric analysis, energy-dispersive X-ray spectroscopy and cyclic voltammetry. The exfoliation conditions were found to have a significant impact on the yield, morphology, structure and properties of the graphene particles produced by electrochemical exfoliation of the graphite. The graphene prepared using (NH₄)₂HPO₄ salt showed an astonishing thermal stability in air at temperatures of up to 700° C.; most high surface area carbon materials are unstable at around 400° C. to 500° C. Utilizing (NH₄)₂HPO₄ also resulted in the highest production rate compared to NaCl, Na₂SO₄, (NH₄)₂SO₄ and NH₄NO₃. A graphene exfoliated using (NH₄)₂HPO₄ drop cast on a glassy carbon electrode (GCE) demonstrated the highest electrocatalytic activity for phenol oxidation compared to samples prepared with other salts. Increasing the exfoliation cell voltage from 5 V to 10 V resulted in faster exfoliation, but didn't affect the catalytic activity of the prepared graphene. Increasing the salt concentration from 0.05M to 1 M influenced the production rate and also changed the catalytic activity of the graphene.

### Example 1: Electrochemical Exfoliation Procedure for Graphene Synthesis: Two Stage Process

The synthetic procedure of this Example involves two stages:
A—Intercalation of the graphite; and,
B— Exfoliation of the intercalated graphite.

Each of these stages is described in detail below.

Stage A—Intercalation of the graphite:
1—The electrochemical intercalation of the graphene was conducted in a 150-ml beaker. A DC power supply was used as a power source.
2—The electrolyte used for intercalation is a mixture of concentrated (95-98%) sulfuric acid H₂SO₄ and concentrated (85%) phosphoric acid H₃PO₄, with a volume ratio of 95:5 to 80:20. (this ratio may vary widely, for example from 95:5 to 50:50). To prepare the electrolyte in a 95:5 ratio, 133 ml of concentrated sulfuric salt was added to 7 ml of concentrated phosphoric acid. Intercalation with concentrated sulfuric acid alone was also carried out for comparison.
3—A flexible graphite sheet (5 cm⁻²) is used as the anode.
4—The cathode can be a stable metal, such as stainless steel or platinum, or graphite.
5—A volume of 100 ml of the acidic electrolyte, prepared as described in step 2, was poured into the beaker forming the electrolytic cell.
6—To perform the electrochemical intercalation, a fixed DC current density was applied to the electrodes immersed in the acid electrolyte, in the exemplified embodiment the current density was ˜20 mA per cm² of the graphite anode.
7—The constant current was applied to the cell for between 800 s and 3600 s.

Stage B—Exfoliation of the intercalated graphite:
8—After the electrochemical intercalation, the electrodes were removed from the beaker and a another 150 ml beaker containing an inorganic salt solution was used for exfoliation.
9—Two alternative solutions were used as the exfoliation electrolyte
   a. 0.1 M (NH₄)₂SO₄: to prepare a 0.1 M solution of (NH₄)₂SO₄, 1.32 g of (NH₄)₂SO₄ salt is dissolved in 100 ml of deionized water.
   b. 0.1 M (NH₄)₂HPO₄: to prepare a 0.1 M solution of (NH₄)₂HPO₄, 1.32 g of the (NH₄)₂HPO₄ salt is dissolved in 100 ml of deionized water.
10—The intercalated graphite sheet (5 cm⁻²) from Stage A was used as the anode.
11—The cathode can be selected from stable electrode materials such as stainless steel, graphite, or platinum.
12—A volume of 100 ml of the electrolyte described in step 9 was poured into the beaker.
13—To perform the electrochemical exfoliation, either
   (a) Fix the distance between the electrodes at 2 cm, and apply a constant DC voltage of 10 V between the anode and cathode; or,
   (b) Apply a fixed DC current density to the electrodes of ˜20 mA per cm² of the graphite anode.
14—Continue to apply the DC voltage or current to the cell until the graphite has fully exfoliated. In the exemplified embodiments, this typically took 15 to 60 min depending on the intercalation time and acid solution. Exfoliation can for example be discontinued when either (a) the current drops close to 0 A (if a DC voltage is applied) or (b) the cell voltage increases significantly e.g. above 20 V (if a DC current is applied).
15—After the electrochemical exfoliation, the electrodes are removed from the beaker, and dispersed exfoliated graphite is filtered using a 400 μm HTTP membrane and washed with deionized water by vacuum filtration, to obtain a filter cake.
16—The filter cake was peeled from the filter, and transferred to a beaker containing 150 ml of either deionized water or dimethylformamide (DMF) and then sonicated and dispersed in that medium using a bath sonicator for 1 h.
17—The dispersed exfoliated graphite is poured into a centrifuge bottle and is centrifuged at 1000 rpm for 10 min to separate the large unexfoliated particles. The supernatant can be decanted to another centrifuge bottle, and the precipitate discarded.
18—The remaining dispersed graphene and graphene nanoplatelets can be stored in solution or can be further centrifuged at 20000 rpm for 60 min.
19—After the second centrifugation, The supernatant can be decanted off and discarded.
20—The remaining separated solids may then be freeze-dried, for example under vacuum for 24 h at −50° C.

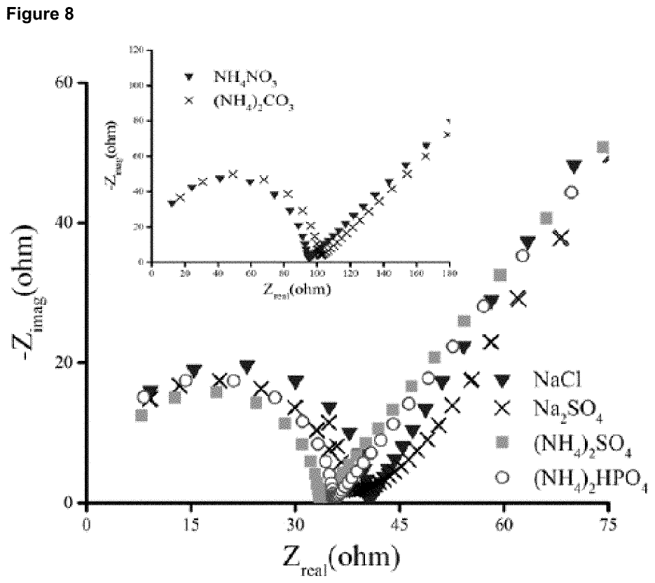

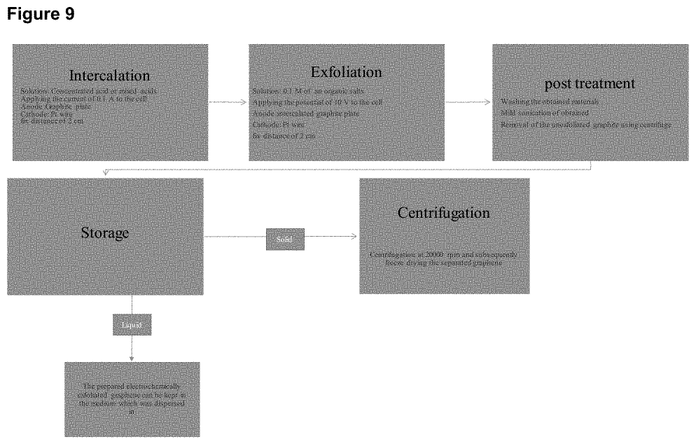

The foregoing process is schematically illustrated in FIG. 9.

### Example 2: Electrochemical Exfoliation Procedure for Graphene Synthesis: Single Stage Process

1—The electrochemical synthesis of the graphene was conducted in a 150-ml beaker. A DC power supply was used as a power source.
2—The solution used as the electrolyte was a mixture of ammonium sulfate (NH₄)₂SO₄ and diammonium phosphate (NH₄)₂HPO₄. The sum of the concentrations of (NH₄)₂SO₄ and (NH₄)₂HPO₄ was maintained at 0.1 M and the ratio between the two was varied from 9:1 to 1:1. An optimized embodiment had a ratio of 7:3 [0.07 M (NH₄)₂SO₄, 0.03 M (NH₄)₂HPO₄], which under the exemplary conditions was found to give the highest quality graphene based on the fraction of the graphite nanoplatelets comprising single layer graphene nanoparticles. For comparison exfoliation in pure 0.1M (NH₄)₂SO₄ and 0.1 M (NH₄)₂HPO₄ electrolytes were also performed.
3—A flexible graphite sheet (5 cm⁻²) was used as the anode.
4—The cathode can be selected from stable electrode materials such as stainless steel, graphite, or platinum.
5—A volume of 100 ml of the electrolyte described in step 2 was poured into the beaker.
6—To perform the electrochemical exfoliation, either
   (a) Fix the distance between the electrodes at 2 cm, and apply a constant DC voltage of 10 V between the anode and cathode; or
   (b) apply a fixed DC current density to the electrodes of ˜20 mA per cm² of the graphite anode.
7—Continue to apply the DC voltage or current to the cell until the graphite foil has fully exfoliated. This typically takes 360 to 480 min. The exfoliation can be stopped when either (a) the current drops to 0 A (if a DC voltage is applied) or (b) the cell voltage increases significantly e.g. above 20 V (if a DC current is applied).
8—After the electrochemical exfoliation, the electrodes are removed from the beaker, and dispersed exfoliated graphite is filtered using a 400 om HTTP membrane and washed with DI water using a vacuum filtration.
9—The obtained filter cake can be easily peeled off from the filter. Afterward, it is transferred to a beaker containing 150 ml of DI water and is sonicated and dispersed in DI water using a bath sonicator for 1 h.
10—The dispersed exfoliated graphite is poured into a centrifuge bottle and is centrifuged at 1000 rpm for 10 min to separate the large unexfoliated particles. The supernatant will be decanted off to another centrifuge bottle. Precipitate will be discarded.
11—The remaining dispersed graphene and graphene nanoplatelets can be stored in water or can be further centrifuged at 20000 rpm for 60 min.
12—After the second centrifugation, The supernatant will be decanted and discarded.
13—The remained separated solids are then freeze-dried under vacuum for 24 h at −50° C.

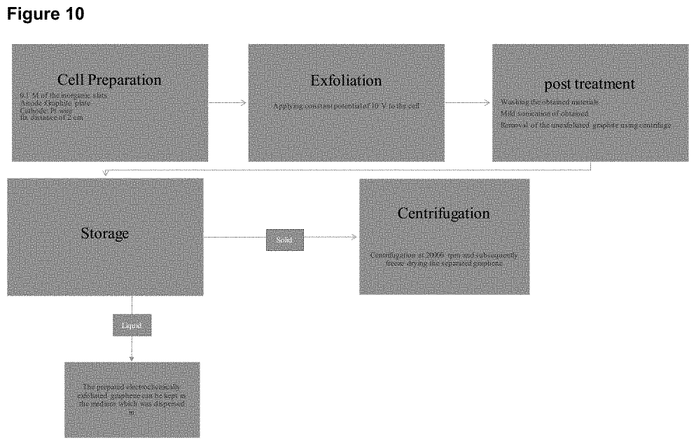

The foregoing process is schematically illustrated in FIG. 10.

### Example 3: Characterization of Single Step EEP Graphene

The results discussed in the Detailed Description were obtained as follows. The electrochemical synthesis of the graphene was conducted in a 150-ml beaker where a DC power supply was used as a power source. 100 ml of inorganic salts in different concentrations (0.05, 0.1, 0.5 and 1 M) was used as electrolyte and the voltage was varied between 3 to 10 V. Pt wire and graphite plate (5 cm⁻²) were used as cathode and anode, respectively. After electrochemical exfoliation, the resultant product was filtered and washed with deionized water using a vacuum filtration using a HTTP membrane. The material obtained was sonicated and dispersed in deionized water, then centrifuged to remove large un-exfoliated graphene particles.

Transmission electron microscopy (TEM) was used to characterize the morphology and nanostructure of the exfoliated graphene. The TEM used was a Tecnai TF20 G2 FEG-TEM (FEI, Hillsboro, Oreg., USA) instrument operating at 200 kV acceleration voltage with a standard single-tilt holder. Raman spectra were recorded on a WITec alpha 300 R Confocal Raman Microscope (WITec GmbH, Germany) using a 532-nm laser. A thermogravimetric analyzer (TA Instruments, Q500) was used to obtain TGA data under nitrogen and air atmosphere from room temperature to 1073 K, with a rate of heating at 10 K min⁻¹. Energy Dispersive X-ray Spectroscopy (EDX) was performed using benchtop SEM-EDX to analyze the present elements in the prepared materials.

The electrochemical characteristics of exfoliated graphene were illustrated by cyclic voltammetry using a conventional three electrode system with a 0.05 M phosphate buffer electrolyte containing 100 ppm phenol, a platinum wire counter electrode, silver/silver chloride reference electrode and modified glassy carbon working electrode. Glassy carbon was polished using alumina solution (0.05 Mm) and subsequently sonicated in H₂SO₄ (0.05 M) and ethanol. drop casting method was used to prepare the working electrode by adding of 15 pL of a suspension of the exfoliated graphene onto the glassy carbon electrode (diameter of 5 mm). Suspensions were prepared by mixing the exfoliated graphene with a suspension Nafion to act as a binder (1:1:0.04 water: ethanol: nafion). Cyclic Voltammetry was conducted via an Autolab PGSTAT (Metrohm, UK), with a potential range from −0.2 and 1.2 V (versus Ag/AgCl) and a scan rate of 20 mV s⁻¹.

Electrochemical impedance spectroscopy was carried in a solution containing 2.5 mM [Fe(CN)₆]^{4-/3-} and 0.1 M KCl supporting electrolyte using a BioLogic potentiostat (BioLogic S200) in the frequency range of 0.1 Hz to 1 MHz.

### Example 4: Characterization of Two Step EEP Graphene

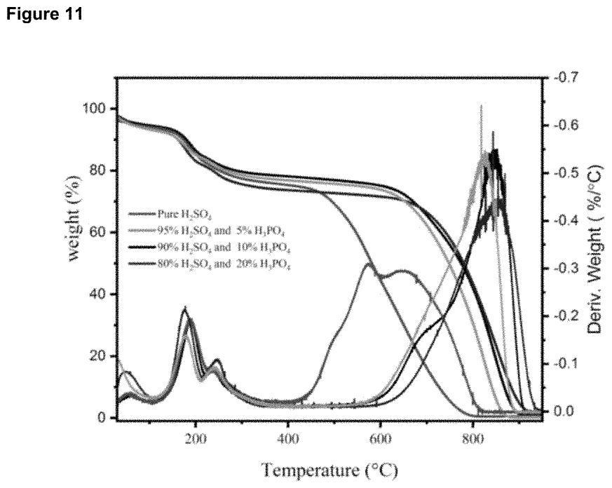

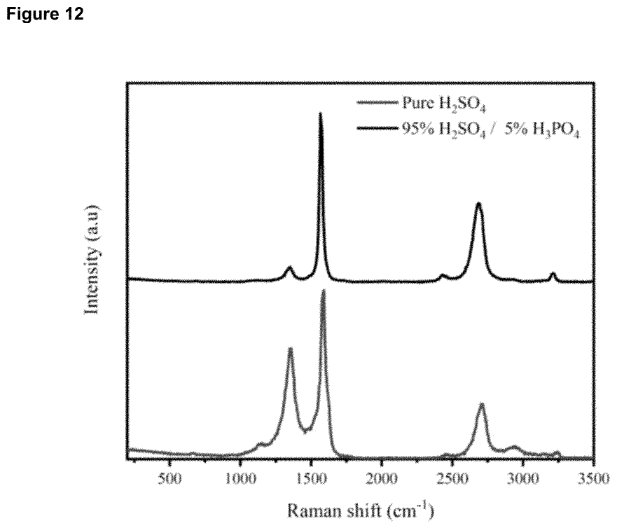

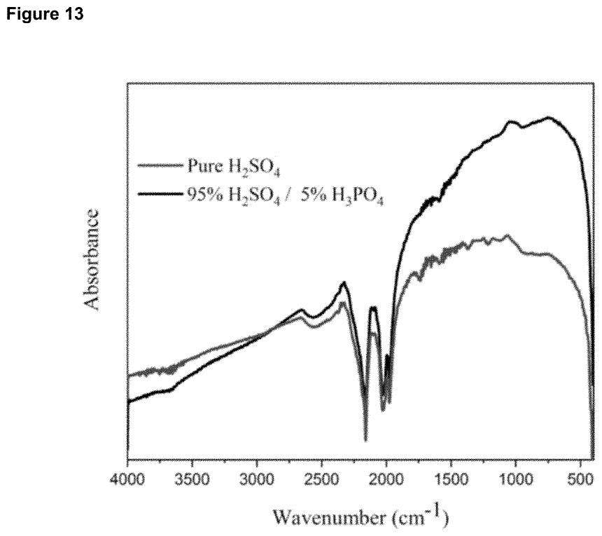

FIG. 11, FIG. 12 and FIG. 13 illustrate respectively, the results of thermal gravimetric analysis, Raman spectra and FTIR of EEP graphene obtained by the two step intercalation and exfoliation process described above.

### Example 5: Electrical Conductivity of EEP Graphene

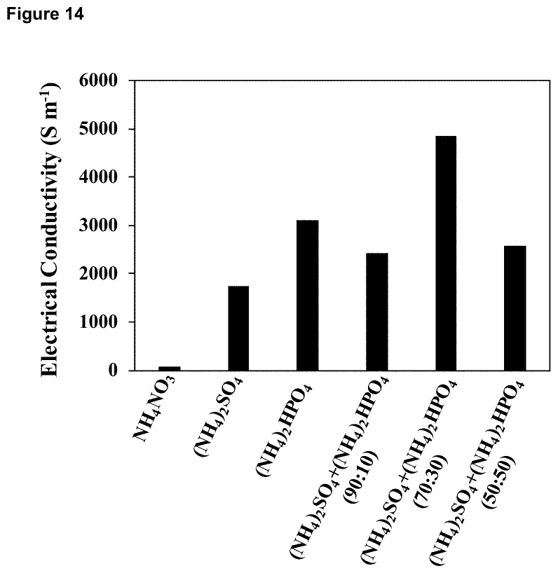

As shown in FIG. 14 the electrical conductivity trend for as prepared EEP graphene films is: σ_{(NH}_{₄}₎_{₂}_{HPO}_{₄}_{+(NH}_{₄}₎_{₂}_{SO}_{₄}_{(70:30)}=(48.6±0.6)×10² S/m>σ_{(NH}_{₄}₎_{₂}_{HPO}_{₄}=(31.1±1.1)×10² S/m>σ_{(NH}_{₄}₎_{₂}_{HPO}_{₄}_{+(NH}_{₄}₎_{₂}_{SO}_{₄}_{(50:50)}=(25.7±5.7)×10² S/m>σ_{(NH}_{₄}₎_{₂}_{HPO}_{₄}_{+(NH}_{₄}₎_{₂}_{SO}_{₄}_{(90:10)}=(24.3±2.7)×10² S/m>σ_{(NH}_{₄}₎_{₂}_{SO}_{₄}=(17.6±0.1)×10² S/m>σ_{NH}_{₄}_{NO}_{₃}=(0.9±0.1)×10². With the exception of the EEP graphene prepared using NH₄NO₃, the conductivities are excellent. The addition of the (NH₄)₂HPO₄ to the electrolyte prevents excessive oxidation of the graphene, lowering the degree of oxidation, consequently increasing the conductivity. The higher electrical conductivity of the 70-30 mixed (NH₄)₂SO₄/(NH₄)₂HPO₄ electrolyte EEP graphene is indicative of the fact that this material has the lowest level of oxidation. In accordance with further aspects of the present innovations, the conductivities of the EEP graphene may be increased by thermal annealing or chemical reduction.

### REFERENCES

[1] X. Duan, C. Zhao, W. Liu, X. Zhao, L. Chang, Fabrication of a novel PbO2 electrode with a graphene nanosheet interlayer for electrochemical oxidation of 2-chlorophenol, Electrochim. Acta. 240 (2017) 424-436. doi:10.1016/J.ELECTACTA.2017.04.114.
[2] M. A. Betiha, A. M. Rabie, H. S. Ahmed, A. A. Abdelrahman, M. F. El-Shahat, Oxidative desulfurization using graphene and its composites for fuel containing thiophene and its derivatives: An update review, Egypt. J. Pet. (2017). doi:10.1016/J.EJPE.2017.10.006.
[3] Y. Cheng, J. Lin, K. Xu, H. Wang, X. Yao, Y. Pei, S. Yan, M. Qiao, B. Zong, Fischer-Tropsch Synthesis to Lower Olefins over Potassium-Promoted Reduced Graphene Oxide Supported Iron Catalysts, ACS Catal. 6 (2016) 389-399. doi:10.1021/acscatal.5b02024.
[4] H. Zhao, Q. Zhu, Y. Gao, P. Zhai, D. Ma, Iron oxide nanoparticles supported on pyrolytic graphene oxide as model catalysts for Fischer Tropsch synthesis, Appl. Catal. A Gen. 456 (2013) 233-239. doi:10.1016/J.APCATA.2013.03.006.
[5] Y. Gao, Y. Li, L. Zhang, H. Huang, J. Hu, S. M. Shah, X. Su, Adsorption and removal of tetracycline antibiotics from aqueous solution by graphene oxide, J. Colloid Interface Sci. 368 (2012) 540-546. doi:10.1016/J.JCIS.2011.11.015.
[6] V. Chandra, K. S. Kim, Highly selective adsorption of Hg2+ by a polypyrrole-reduced graphene oxide composite, Chem. Commun. 47 (2011) 3942-3944. doi:10.1039/C1CC00005E.
[7] R. Imran Jafri, N. Rajalakshmi, S. Ramaprabhu, Nitrogen doped graphene nanoplatelets as catalyst support for oxygen reduction reaction in proton exchange membrane fuel cell, J. Mater. Chem. 20 (2010) 7114-7117. doi:10.1039/C0JM00467G.
[8] S. Yuyan, W. Jun, W. Hong, L. Jun, A. I. A., L. Yuehe, Graphene Based Electrochemical
Sensors and Biosensors: A Review, Electroanalysis. 22 (n.d.) 1027-1036. doi:10.1002/elan.200900571.
[9] Z.-S. Wu, W. Ren, L. Wen, L. Gao, J. Zhao, Z. Chen, G. Zhou, F. Li, H.-M. Cheng, Graphene Anchored with Co3O4 Nanoparticles as Anode of Lithium Ion Batteries with Enhanced Reversible Capacity and Cyclic Performance, ACS Nano. 4 (2010) 3187-3194. doi:10.1021/nnl 00740x.
[10] K. S. Novoselov, A. K. Geim, S. V Morozov, D. Jiang, Y. Zhang, S. V Dubonos, I. V Grigorieva, A. A. Firsov, Electric Field Effect in Atomically Thin Carbon Films, Science (80-.). 306 (2004) 666-669. http://science.sciencemag.org/content/306/5696/666. abstract.
[11] A. Ambrosi, M. Pumera, The CVD graphene transfer procedure introduces metallic impurities which alter the graphene electrochemical properties, Nanoscale. 6 (2014) 472-476. doi:10.1039/C3NR05230C.
[12] S. Pei, H.-M. Cheng, The reduction of graphene oxide, Carbon N. Y. 50 (2012) 3210-3228. doi:10.1016/J.CARBON.2011.11.010.
[13] R. Gondosiswanto, X. Lu, C. Zhao, Preparation of Metal-Free Nitrogen-Doped Graphene Via Direct Electrochemical Exfoliation of Graphite in Ammonium Nitrate, Aust. J. Chem. 68 (2015) 830-835. https://doi.org/10.1071/CH14447.
[14] J. Lu, J. Yang, J. Wang, A. Lim, S. Wang, K. P. Loh, One-Pot Synthesis of Fluorescent Carbon Nanoribbons, Nanoparticles, and Graphene by the Exfoliation of Graphite in Ionic Liquids, ACS Nano. 3 (2009) 2367-2375. doi:10.1021/nn900546b.
[15] X. Lu, C. Zhao, Controlled electrochemical intercalation{,} exfoliation and in situ nitrogen doping of graphite in nitrate-based protic ionic liquids, Phys. Chem. Chem. Phys. 15 (2013) 20005-20009. doi:10.1039/C3CP53917B.
[16] J. Liu, C. K. Poh, D. Zhan, L. Lai, S. H. Lim, L. Wang, X. Liu, N. Gopal Sahoo, C. Li, Z. Shen, J. Lin, Improved synthesis of graphene flakes from the multiple electrochemical exfoliation of graphite rod, Nano Energy. 2 (2013) 377-386. doi:10.1016/J.NANOEN.2012.11.003.
[17] J. Liu, H. Yang, S. G. Zhen, C. K. Poh, A. Chaurasia, J. Luo, X. Wu, E. K. L. Yeow, N. G. Sahoo, J. Lin, Z. Shen, A green approach to the synthesis of high-quality graphene oxide flakes via electrochemical exfoliation of pencil core, RSC Adv. 3 (2013) 11745-11750. doi:10.1039/C3RA41366G.
[18] K. Chen, D. Xue, Preparation of colloidal graphene in quantity by electrochemical exfoliation, J. Colloid Interface Sci. 436 (2014) 41-46. doi:10.1016/J.JCIS.2014.08.057.
[19] N. Parveen, M. O. Ansari, M. H. Cho, Simple route for gram synthesis of less defective few layered graphene and its electrochemical performance, RSC Adv. 5 (2015) 44920-44927. doi:10.1039/C5RA06404J.
[20] K. Parvez, Z.-S. Wu, R. Li, X. Liu, R. Graf, X. Feng, K. Müllen, Exfoliation of Graphite into Graphene in Aqueous Solutions of Inorganic Salts, J. Am. Chem. Soc. 136 (2014) 6083-6091. doi:10.1021/ja5017156.
[21] J. Cao, P. He, M. A. Mohammed, X. Zhao, R. J. Young, B. Derby, I. A. Kinloch, R. A. W. Dryfe, Two-Step Electrochemical Intercalation and Oxidation of Graphite for the Mass Production of Graphene Oxide, J. Am. Chem. Soc. 139 (2017) 17446-17456. doi:10.1021/jacs.7b08515.
[22] S. Pei, Q. Wei, K. Huang, H.-M. Cheng, W. Ren, Green synthesis of graphene oxide by seconds timescale water electrolytic oxidation, Nat. Commun. 9 (2018) 145. doi:10.1038/s41467-017-02479-z.
[23] H. Wang, T. Maiyalagan, X. Wang, Review on Recent Progress in Nitrogen-Doped Graphene: Synthesis, Characterization, and Its Potential Applications, ACS Catal. 2 (2012) 781-794. doi:10.1021/cs200652y.
[24] L. Lai, J. R. Potts, D. Zhan, L. Wang, C. K. Poh, C. Tang, H. Gong, Z. Shen, J. Lin, R. S. Ruoff, Exploration of the active center structure of nitrogen-doped graphene-based catalysts for oxygen reduction reaction, Energy Environ. Sci. 5 (2012) 7936-7942. doi:10.1039/C2EE21802J.
[25] A. L. M. Reddy, A. Srivastava, S. R. Gowda, H. Gullapalli, M. Dubey, P. M. Ajayan, Synthesis Of Nitrogen-Doped Graphene Films For Lithium Battery Application, ACS Nano. 4 (2010) 6337-6342. doi:10.1021/nn101926g.
[26] R. Lv, Q. Li, A. R. Botello-Mendez, T. Hayashi, B. Wang, A. Berkdemir, Q. Hao, A. L. Elias, R. Cruz-Silva, H. R. Gutierrez, Y. A. Kim, H. Muramatsu, J. Zhu, M. Endo, H. Terrones, J.-C. Charlier, M. Pan, M. Terrones, Nitrogen-doped graphene: beyond single substitution and enhanced molecular sensing, Sci. Rep. 2 (2012) 586. http://dx.doi.org/10.1038/srep00586.
[27] H. M. Jeong, J. W. Lee, W. H. Shin, Y. J. Choi, H. J. Shin, J. K. Kang, J. W. Choi, Nitrogen-Doped Graphene for High-Performance Ultracapacitors and the Importance of Nitrogen-Doped Sites at Basal Planes, Nano Lett. 11 (2011) 2472-2477. doi:10.1021/n12009058.
[28] X.-H. Li, J.-S. Chen, X. Wang, J. Sun, M. Antonietti, Metal-Free Activation of Dioxygen by Graphene/g-C3N4 Nanocomposites: Functional Dyads for Selective Oxidation of Saturated Hydrocarbons, J. Am. Chem. Soc. 133 (2011) 8074-8077. doi:10.1021/ja200997a.
[29] Z.-H. Sheng, X.-Q. Zheng, J.-Y. Xu, W.-J. Bao, F.-B. Wang, X.-H. Xia, Electrochemical sensor based on nitrogen doped graphene: Simultaneous determination of ascorbic acid,
dopamine and uric acid, Biosens. Bioelectron. 34 (2012) 125-131. doi:https://doi.org/10.1016/j.bios.2012.01.030.
[30] L.-S. Zhang, X.-Q. Liang, W.-G. Song, Z.-Y. Wu, Identification of the nitrogen species on N-doped graphene layers and Pt/NG composite catalyst for direct methanol fuel cell, Phys. Chem. Chem. Phys. 12 (2010) 12055-12059. doi:10.1039/C0CP00789G.
[31] L. Ji, J. Yan, J. Mietek, Q. S. Zhang, Sulfur and Nitrogen Dual-Doped Mesoporous Graphene Electrocatalyst for Oxygen Reduction with Synergistically Enhanced Performance, Angew. Chemie Int. Ed. 51 (2012) 11496-11500. doi:10.1002/anie.201206720.
[32] A. Zehtab Yazdi, H. Fei, R. Ye, G. Wang, J. Tour, U. Sundararaj, Boron/Nitrogen Co-Doped Helically Unzipped Multiwalled Carbon Nanotubes as Efficient Electrocatalyst for Oxygen Reduction, ACS Appl. Mater. Interfaces. 7 (2015) 7786-7794. doi:10.1021/acsami.5b01067.
[33] Z. Chenzhen, M. Nasir, Y. Han, L. Fei, H. Yanglong, Synthesis of Phosphorus-Doped Graphene and its Multifunctional Applications for Oxygen Reduction Reaction and Lithium Ion Batteries, Adv. Mater. 25 (2013) 4932-4937. doi:10.1002/adma.201301870.
[34] X. Wu, L. R. Radovic, Inhibition of catalytic oxidation of carbon/carbon composites by phosphorus, Carbon N. Y. 44 (2006) 141-151. doi:https://doi.org/10.1016/j.carbon.2005.06.038.
[35] S. A. Suvorov, E. V Chaikun, S. L. Korobkin, G. S. Sokolova, Protective mechanism of phosphorus-containing coatings, Refractories. 29 (1988) 544-547. doi:10.1007/BF01287784.
[36] S. Labruquère, R. Pailler, R. Naslain, B. Desbat, Oxidation Inhibition of Carbon Fibre
Preforms and C/C Composites by H3PO4, J. Eur. Ceram. Soc. 18 (1998) 1953-1960. doi:10.1016/SO₉₅₅-2219(98)00135-6.
[37] J. M. Rosas, R. Ruiz-Rosas, J. Rodriguez-Mirasol, T. Cordero, Kinetic study of the oxidation resistance of phosphorus-containing activated carbons, Carbon N. Y. 50 (2012) 1523-1537. doi:10.1016/J.CARBON.2011.11.030.
[38] W. Lu, D. D. L. Chung, Oxidation protection of carbon materials by acid phosphate impregnation, Carbon N. Y. 40 (2002) 1249-1254. doi:10.1016/S0008-6223(01)00297-4.
[39] J. M. Rosas, J. Bedia, J. Rodriguez-Mirasol, T. Cordero, HEMP-derived activated carbon fibers by chemical activation with phosphoric acid, Fuel. 88 (2009) 19-26. doi:10.1016/J.FUEL.2008.08.004.
[40] Y. Wang, S. Zuo, J. Yang, S.-H. Yoon, Evolution of Phosphorus-Containing Groups on Activated Carbons during Heat Treatment, Langmuir. 33 (2017) 3112-3122. doi:10.1021/acs.langmuir.7b00095.
[41] D. W. McKee, C. L. Spiro, E. J. Lamby, The effects of boron additives on the oxidation behavior of carbons, Carbon N. Y. 22 (1984) 507-511. doi:10.1016/0008-6223(84)90083-6.
[42] S. G. Oh, N. M. Rodriguez, In situ electron microscopy studies of the inhibition of graphite oxidation by phosphorus, J. Mater. Res. 8 (1993) 2879-2888. doi:10.1557/JMR.1993.2879.
[43] T. A. Enache, A. M. Oliveira-Brett, Phenol and para-substituted phenols electrochemical oxidation pathways, J. Electroanal. Chem. 655 (2011) 9-16. doi:10.1016/J.JELECHEM.2011.02.022.
[44] J. Mathiyarasu, J. Joseph, K. L. N. Phani, V. Yegnaraman, Electrochemical detection of phenol in aqueous solutions, Indian J. Chem. Technol. 11(2004) 797-803.
[45] Y. Wang, Y. Shao, D. W. Matson, J. Li, Y. Lin, Nitrogen-Doped Graphene and Its Application in Electrochemical Biosensing, ACS Nano. 4 (2010) 1790-1798. doi:10.1021/nn100315s.
[46] M. Wei, L. Qiao, H. Zhang, S. Karakalos, K. Ma, Z. Fu, M. T. Swihart, G. Wu, Engineering reduced graphene oxides with enhanced electrochemical properties through multiple-step reductions, Electrochim. Acta. 258 (2017) 735-743. doi:10.1016/J.ELECTACTA.2017.11.120.

[47] S. Y. Toh, K. S. Loh, S. K. Kamarudin, W. R. W. Daud, The impact of electrochemical reduction potentials on the electrocatalytic activity of graphene oxide toward the oxygen reduction reaction in an alkaline medium, Electrochim. Acta. 199 (2016) 194-203. doi:10.1016/J.ELECTACTA.2016.03.103.
[48] T. EL OUAFY, A. CHTAINI, H. OULFAJRITE, R. NAJIH, Electrochemical determination of phenol at natural phosphate modified carbon paste electrode, Leonardo Electron. J. Pract. Technol. 13 (2014) 166-178.
[49] S. A. Kumar, H.-W. Cheng, S.-M. Chen, S.-F. Wang, Preparation and characterization of copper nanoparticles/zinc oxide composite modified electrode and its application to glucose sensing, Mater. Sci. Eng. C. 30 (2010) 86-91. doi:10.1016/J.MSEC.2009.09.001.
[50] J. Yang, S. Gunasekaran, Electrochemically reduced graphene oxide sheets for use in high performance supercapacitors, Carbon N. Y. 51 (2013) 36-44. doi:10.1016/J.CARBON.2012.08.003.
[51] Y. Chen, X. Zhang, D. Zhang, P. Yu, Y. Ma, High performance supercapacitors based on reduced graphene oxide in aqueous and ionic liquid electrolytes, Carbon N. Y. 49 (2011) 573-580. doi:10.1016/J.CARBON.2010.09.060.

1. An electrochemically exfoliated phosphated (EEP) graphene, comprising phosphorous-containing functional groups at a surface of the EEP graphene in an amount sufficient to improve thermal stability of the EEP graphene compared to a graphene lacking the phosphorous-containing functional groups.

2. The EEP graphene of claim 1, wherein a thermal gravimetric temperature measurement at 50% mass loss in air is at least 550, 600, 650, 700, 750, 800, 850 or 873° C.

3. An electrode comprising the EEP graphene of claim 1.

4. A process for synthesizing electrochemically exfoliated phosphated graphene, comprising applying an electrochemical exfoliation current to an exfoliation anode comprising a graphite sample in a phosphating electrolyte that is an inorganic salt solution comprising diammonium phosphate (NH₄)₂HPO₄ and/or mono-ammonium phosphate (NH₄)H₂PO₄.

5. The process of claim 4, wherein the electrochemical exfoliation current is a DC current.

6. The process of claim 5, wherein the DC current density applied to the electrode is about 20 mA per cm² of the graphite anode, or from 5 to 500 mA/cm².

7. The process of claim 9, wherein the phosphating electrolyte further comprises one or more of (NH₄)₂SO₄, NH₄NO₃, H₂SO₄, or Na₂SO₄; or, is a mixture of ammonium sulfate (NH₄)₂SO₄ and diammonium phosphate (NH₄)₂HPO₄.

8. The process of claim 7, wherein phosphating electrolyte comprises a total salt concentration of about 0.1 M, or from 0.05 M to saturated solution; or, the sum of the concentrations of (NH₄)₂SO₄ and (NH₄)₂HPO₄ is maintained at about 0.1 M, or from 0.05 M to saturated solution.

9. The process of claim 7, wherein the ratio between (NH₄)₂SO₄ and (NH₄)₂HPO₄ is from 9:1 to 1:1; or, is about 7:3.

10. The process of claim 8, wherein the ratio between (NH₄)₂SO₄ and (NH₄)₂HPO₄ is from 9:1 to 1:1; or, is about 7:3.

11. A process for synthesizing electrochemically exfoliated phosphated graphene, comprising intercalation of a graphite sample to provide an intercalated graphite; and, exfoliation of the intercalated graphite to provide the electrochemically exfoliated phosphated graphene, wherein:
intercalation of the graphite sample comprises applying an electrochemical intercalation current to an intercalation anode comprising the graphite sample in an acidic aqueous intercalation electrolyte comprising phosphoric acid in electrical contact with an intercalation cathode; and,
exfoliation of the intercalated graphite comprises applying an electrochemical exfoliation current to an exfoliation anode comprising the intercalated graphite in an inorganic salt solution electrolyte in electrical contact with an exfoliation cathode.

12. The process of claim 11, wherein the inorganic salt solution comprises diammonium phosphate (NH₄)₂HPO₄ and/or mono-ammonium phosphate (NH₄)H₂PO₄.

13. The process of claim 12, wherein the inorganic salt solution comprises one or more of ammonium sulfate (NH₄)₂SO₄, NH₄NO₃, H₂SO₄, or Na₂SO₄.

14. The process of claim 13, wherein the total inorganic salt concentration, or the (NH₄)₂SO₄ concentration, is 0.1 M, or from 0.05 M to saturated solution.

15. The process of claim 13, wherein the (NH₄)₂HPO₄ and/or (NH₄)H₂PO₄ solution is 0.1 M, or from 0.05 M to a saturated solution.

16. The process of claim 11, wherein the intercalation cathode and/or the exfoliation cathode is stainless steel, graphite, or platinum.

17. The process of claim 11, wherein applying the electrochemical intercalation current and/or the electrochemical exfoliation current comprises fixing the distance between the electrodes and apply a constant DC voltage the anode and cathode.

18. The process of claim 11, wherein applying the electrochemical intercalation current and/or the electrochemical exfoliation current comprises applying a fixed DC current density to the electrodes.

19. The process of claim 18, wherein the fixed DC current density of the electrochemical exfoliation current is about 20 mA per cm² of the intercalated graphite on the anode, or from 5 to 500 mA/cm².

20. The process of claim 11, further comprising applying the electrochemical exfoliation current to the cell until the intercalated graphite has fully exfoliated.

21. The process of claim 11, wherein the intercalation electrolyte comprises a mixture of sulfuric and phosphoric acids.

22. The process of claim 21, wherein the sulfuric acid is concentrated (optionally 95-98%) sulfuric acid.

23. The process of claim 21, wherein the phosphoric acid is concentrated phosphoric acid (optionally 85%).

24. The process of claim 21, wherein the volume ratio of sulphuric to phosphoric acid is from 95:5 to 80:20.

25. The process of claim 21, wherein the volume ratio of sulphuric acid to phosphoric acid is from 50:50 to 95:5.

26. The process of claim 21, wherein the graphite sample is a flexible graphite sheet.
